(19) United States
(12) Patent Application Publication
(10) Pub. No.: US 2025/0091283 A1
(43) Pub. Date: Mar. 20, 2025

(54) FILAMENT WINDING MACHINE AND METHOD WITH RESIN APPLICATION

(71) Applicant: MF TECH, QUEVEN (FR)

(72) Inventor: Alexander Hamlyn, Ploemeur (FR)

(21) Appl. No.: 18/832,720

(22) PCT Filed: Jan. 20, 2023
(86) PCT No.: PCT/FR2023/000010

§ 371 Date: Jul. 24, 2024

(30) Foreign Application Priority Data
Jan. 25, 2022 (FR) FR2200629

(51) Int. Cl. B29C 53/80; B29C 53/58; B29L 31/00

(52) U.S. Cl. CPC B29C 53/8016; B29C 53/582; B29C 53/8066; B29L 2031/7156

(57) ABSTRACT

A filament winding machine and method for winding a fibrous ply onto a body, the machine comprising at least one winding head having a final guide member, a movement system capable of rotating the body and of moving the body relative to the winding head, and a resin application system capable of applying a resin composition to the fibrous ply. The resin application system comprises a nozzle capable of coating one of the main faces of the fibrous ply with a resin composition upstream of the final guide member and a feed device capable of supplying the nozzle with the resin composition at a flow rate that is regulated according to the travel speed of the fibrous ply.

### CROSS-REFERENCE TO RELATED APPLICATIONS

This application is a U.S. National Phase of PCT/FR2023/000010, filed Jan. 20, 2023, which claims priority to French Application No. FR2200629, filed Jan. 25, 2022, and which applications are incorporated herein by reference.

### TECHNICAL FIELD

The present invention relates to a filament winding machine for winding a fibrous web comprising at least one continuous fiber onto a body, in particular onto a liner for the manufacture of tanks, with a particular resin application system, as well as to a method for manufacturing a fiber-reinforced part comprising the filament winding of a fibrous web onto a body with in-line resin application.

### BACKGROUND

There are known composite tanks for storing pressurized gases, generally comprising a cylindrical central portion and two end portions having decreasing cross-section and rounded towards the outside, classically known as domes. In the case of type IV tanks, the tanks are formed by an inner shell, classically called a liner, defining a sealed storage chamber, and a reinforcing shell, surrounding the liner, which is obtained by filament winding of continuous fibers around the liner, the fibers preferably being pre-impregnated with a resin, generally thermosetting resin, each fiber being formed from a multitude of continuous filaments.

Filament winding is carried out by means of a filament winding machine which typically comprises winding means comprising at least one winding head associated with fiber storage means, and a displacement system able to drive in rotation the liner around its longitudinal axis, and to perform a relative displacement of the liner with respect to the winding means for winding fiber onto the liner.

It is known, notably in patent document DE 10 2010 047 361, such a machine in which the winding means comprise a winding head mounted rotatably on a fixed frame around a horizontal axis. The fibers, coming from fiber spools arranged in a creel, are guided in the form of a web towards the winding head. The displacement system comprises a poly-articulated arm-type robot carrying a gripping device at its end. The gripping device comprises a U-shaped support mounted by its base to the robot's wrist, the liner being mounted by its ends between the two arms of the U and driven in rotation by one of its ends by a motor.

Spools of fiber pre-impregnated with resin can be used. In another wet winding process, dry fiber spools are used, the fibers unwound from the spools are guided in the form of a web towards the winding head, by first passing through an impregnation system, known per se, formed by a resin bath, typically a thermosetting resin bath. The bath consists of a resin composition comprising a resin component and a reactive component, the reactive component comprising, for example, a hardener component. The resins conventionally used are epoxy-type resins. After the winding step, the part is subjected to a vacuum or autoclave curing step to polymerize the resin and form the polymer matrix of the composite material. In the case of a tank, the reinforcing envelope of composite material comprises about 40% by volume of polymer matrix.

Impregnation systems of this type considerably reduce the cost of the raw material, as dry fibers are much cheaper than pre-impregnated fibers. Such a bath limits winding speeds, as the fiber has to pass through the bath for a sufficiently long time to obtain good impregnation of the fiber. In the case of thermosetting resin, the resin bath must be emptied, cleaned and refilled regularly, typically about every 8 hours. Furthermore, in order to have a sufficiently long life, the baths are made with slow polymerization resin compositions with low viscosity, typically less than 0.5 Pa·s at 20° C., which require long autoclave curing steps lasting several hours, which considerably reduces production rates and increases the final cost of the parts. The low viscosity of the resin compositions used means that winding has to be carried out at reduced speeds to limit resin splashes.

### SUMMARY

The aim of the present invention is to propose a winding machine that makes it possible to overcome at least one of the aforementioned disadvantages.

To this end, embodiments of the present invention proposes a filament winding machine for winding a fibrous web comprising at least one continuous fiber, of ribbon type, in particular formed of several flat continuous fibers of ribbon type arranged substantially edge to edge, on a body having a main longitudinal axis, the machine comprising
winding means comprising at least one winding head, associated with fiber storage means, and comprising a final guide member,
a displacement system able to drive the body in rotation and to effect a relative displacement of the body with respect to the winding means for winding the fibrous web onto the body, and
a resin application system able to apply in line a resin composition to the fibrous web,
characterized in that the resin application system comprises application means comprising at least one nozzle able to coat one of the main faces of the fibrous web with a resin composition, preferably in the form of a film or layer, at the winding head, upstream of the final guide member with respect to the running direction of the fibrous web, and a feed device able to feed the resin composition to the nozzle at a rate which is regulated depending on the speed of the fibrous web in front of the nozzle.

According to embodiments of the invention, the machine comprises a nozzle able to apply a resin composition to the fibrous web by coating, upstream of the final guide member. The use of such a nozzle makes it possible to apply in line a resin composition having a high viscosity, for example a viscosity at 50° C. of at least 20 Pa·s, preferably at least 100 Pa·s, more preferably between 100 and 200 Pa·s, and thus to achieve high winding speeds, greater than 1 m/s, preferably greater than 2 m/s. The use of such a nozzle makes it possible to apply resin compositions that are more reactive than those used in the prior art, as the various components of the resin composition can be mixed just upstream of the nozzle.

According to an embodiment, the winding head comprises a final guide member, for example formed by a final eyelet or a final roller, against which the fibrous web comes into contact by a first main face, the nozzle being able to apply a resin composition to the second main face of the fibrous web. The resin composition is applied to the face of the fibrous web that is opposite the final guide member, which avoids removal by scraping of the resin composition as the fibrous web passes over the final guide member. During winding, the face of the fibrous web coated with resin composition is the one facing towards the body, so that winding the web onto the body under tension allows at least partial impregnation of the resin composition through the fibrous web.

According to an embodiment, the nozzle is a slot nozzle, also known as a lip nozzle, equipped with a foil defining a distribution slot, the nozzle being able to apply the resin composition over substantially the entire width of the fibrous web, in the form of a layer or film.

According to an embodiment, the final guide member is formed by a final roller, preferably mounted non-rotatably around its longitudinal axis.

According to an embodiment, the winding head comprises, upstream of the final guide member, in relation to the running direction of the fibrous web, one intermediate guide member or two intermediate guide members, the nozzle being able to apply the resin composition to the fibrous web as it passes over an intermediate guide member, or on the strand of fibrous web arranged between two intermediate members or arranged between an intermediate guide member and the final guide member, preferably on the strand of fibrous web arranged between two intermediate members. Preferably, the final guide member is formed by a final roller mounted non-rotatably around its longitudinal axis, and each intermediate member is formed by an intermediate roller, preferably mounted non-rotatably around its longitudinal axis.

According to an embodiment, the final guide member, preferably formed of a final roller, is mounted pivotably on a head support around a rotation axis, preferably horizontal, the winding head comprising a motor able to pivot the final guide member around the rotation axis, the nozzle being mounted pivotably with the final guide member on the head support, the final guide member being able, for example, to pivot by +/−90° with respect to an initial position.

According to an embodiment, the winding head comprises a mobile ring mounted rotatably around its main axis on a fixed ring which is assembled in a fixed manner on the head support, the mobile ring being provided with at least one arm extending substantially parallel to the main axis, carrying at its end the final guide member, as well as any intermediate guide members, the nozzle being fixed in rotation to the mobile ring, the main axis of the mobile ring constituting the rotation axis of the final guide member. Such a pivoting mounting of the final guide member allows windings to be made along helical trajectories at the level of the tank domes, with satisfactory winding quality. In this case, the nozzle is also mounted pivotably with the end guide member.

According to an embodiment, the feed device comprises resin storage means, dosing means and distribution means, distribution means comprise a valve system comprising at least two inlets connected to the dosing means to be fed with at least two constituent components of the resin composition, for example connected to at least two dosing pumps, in particular of the gear pump type, and an outlet connected to a static mixer for mixing the two components of the resin composition, nozzle being connected directly or indirectly to the outlet of static mixer.

According to an embodiment, the valve system is mounted on the head support, on the upstream side of the mobile ring, the static mixer is mounted rotatably at the outlet of the valve system and extends through the mobile ring, substantially along the main axis of the mobile ring, the static mixer being fixed in rotation to the mobile ring, the nozzle is connected directly to the outlet of the static mixer, and is preferably able to apply the resin composition to the strand disposed between two intermediate guide members mounted on the arm.

In another embodiment, the valve system and the static mixer are fixedly mounted on the support, and the nozzle is mounted on the arm fixed to the mobile ring, and is connected to the outlet of the static mixer via a flexible hose.

According to an embodiment, the winding means comprise at least two winding systems, each winding system comprising a winding head, associated with fiber storage means, and equipped with a nozzle fed with resin composition by the static mixer which is connected to a valve system, the valve systems of the two winding systems being fed with components of the resin composition by common dosing means.

According to an embodiment, the winding means comprise a rotating support or carousel, mounted rotatably around a rotation axis, preferably around a vertical rotation axis, on which at least two winding systems are mounted, each winding system comprising a winding head associated with fiber storage means, so that, by rotation of the rotating support around its rotation axis, each winding system can be moved into an active position for winding a fibrous web by its winding head and an inactive position in which an operator can carry out maintenance operations, the feed device comprising common dosing means, on board the rotating support, able to feed selectively the valve system associated with the winding head of the winding system which is in the active position, and resin storage means arranged in the vicinity of the rotating support, preferably on the ground, feeding the dosing means. In this embodiment, the winding machine comprises a carousel carrying several winding systems, so that when one winding system is in use for winding operations, maintenance operations can be carried out in masked time on the other winding system(s), in particular fiber spool changes and maintenance operations on the nozzle, the distribution system, the final guide member and/or any intermediate guide members. The machine according to the invention thus makes it possible to achieve high production rates. The machine according to the invention is particularly advantageous for the production of high-pressure tanks, with a body constituting the liner of the tank. The rotating support comprises n winding systems, n being an integer greater than or equal to 2, the winding systems being arranged on the rotating support at a regular angular spacing equal to 360°/n. In an embodiment, the rotating support carries two winding systems, each movable between an active position and an inactive position, each winding system being maneuvered between its two positions by a rotation of 180° and/or −180° of the rotating support around its rotation axis between two positions. In another embodiment, the rotating support carries a first, second and third winding system, each movable between an active position and two inactive positions, each winding system being maneuvered between its three positions by +120° and/or −120° rotations of the rotating support around its axis of rotation between three positions.

According to an embodiment, the storage means of each winding system comprise mandrels mounted on a support structure, each mandrel being able to carry a fiber spool, and is associated with a tension regulation system, each winding system comprising guide means able to guide the fibers from the mandrels towards the winding head in order to form a fibrous web at the head.

The displacement system may comprise a first polyarticulated robot and a second polyarticulated robot capable of carrying the body by its ends, so that the body is mounted rotatably around its longitudinal rotation axis by a first end on the first polyarticulated robot and by a second end on the second polyarticulated robot, at least one of the two polyarticulated robots being equipped with a drive motor for rotating the body around its longitudinal axis.

According to an embodiment, each winding system comprises several winding heads, for example two or three winding heads, each associated with fiber storage means and equipped with a nozzle and a valve system. The winding heads are for example arranged one above the other with the rotation axes arranged in the same vertical plane. The machine then preferably comprises a displacement system able to drive several bodies in rotation, the number of which corresponds to the number of winding heads of each winding system, and to effect a relative displacement of the bodies with respect to the winding means for the simultaneous winding of fibrous webs onto the bodies.

Another object of the present invention is a method for manufacturing a fiber-reinforced part comprising filament winding of a fibrous web onto a body, fibrous web comprising at least one flat continuous ribbon-type fiber, preferably formed from a plurality of flat continuous ribbon-type fibers arranged substantially edge to edge, characterized in that the filament winding is carried out by means of a filament winding machine as described above, with in-line application by coating of a resin composition to a first main face of the fibrous web.

Preferably, the process according to the invention comprises the application by hot coating of a resin composition, at a temperature of at least 50° C.

The method according to the invention can be used to produce composite parts with a thermosetting polymer matrix, in which case the resin composition comprises a thermosetting resin component, such as an epoxy resin for example, and a reactive component. After the winding step, the method comprises a heating or curing step to polymerize the resin composition and thus obtain a fiber-reinforced part, preferably comprising at least 30% by volume of polymer matrix. The process according to the invention can also be used to produce composite parts with a thermoplastic polymer matrix, in which case the resin composition comprises a thermoplastic resin component.

According to an embodiment, the process comprises in-line coating by means of a nozzle of a resin composition having a viscosity at 50° C., measured according to the ISO 3219 method, of at least 20 Pa·s, preferably of at least 100 Pa·s, more preferably of between 100 and 200 Pa·s.

According to an embodiment, the winding of the fibrous web is performed so that the main face coated with resin composition is oriented towards the body, the winding of the fibrous web under tension promoting impregnation of the resin composition through the fibrous web during winding. The process preferably comprises, at the end of the step of winding the body, a first step of heating the wound body, at a defined temperature level and for a defined time, to reduce the viscosity of the resin composition and promote impregnation, then a second step of heating the wound body, under vacuum or in an autoclave, also known as the curing step, to polymerize the resin composition and form the polymer matrix of the fiber-reinforced part.

According to an embodiment, for the production of a fiber-reinforced part such as a high-pressure tank, the body constitutes a liner, the fiber-reinforced part being formed by the liner and the fiber mat winding, the liner preferably comprising a substantially cylindrical central portion and first and second domed end portions, the liner being equipped at the end with a spindle for mounting it and for driving it in rotation by the displacement system. In another embodiment, the body constitutes a mandrel, the fiber-reinforced part being formed by the winding of fibrous web.

### BRIEF DESCRIPTION OF THE DRAWINGS

The invention will be better understood, and other purposes, details, features and advantages will become clearer in the course of the following detailed explanatory description of a currently preferred particular embodiment of the invention, with reference to the appended schematic drawings, in which:

FIG. 1 is a schematic perspective view of the winding means of a filament winding machine according to the invention, comprising two winding heads mounted on a carousel, each winding head being equipped with resin application means;

FIG. 2 is a partial schematic perspective view of a winding head of FIG. 1;

FIG. 3 is a partial schematic side view of the filament winding machine according to an embodiment of the invention;

FIG. 4 is a schematic side view of the winding head in FIG. 2;

FIG. 5 is a schematic longitudinal section view of the winding head in FIG. 2; and,

FIG. 6 is a schematic representation of the resin application system of the filament winding machine.

### DETAILED DESCRIPTION

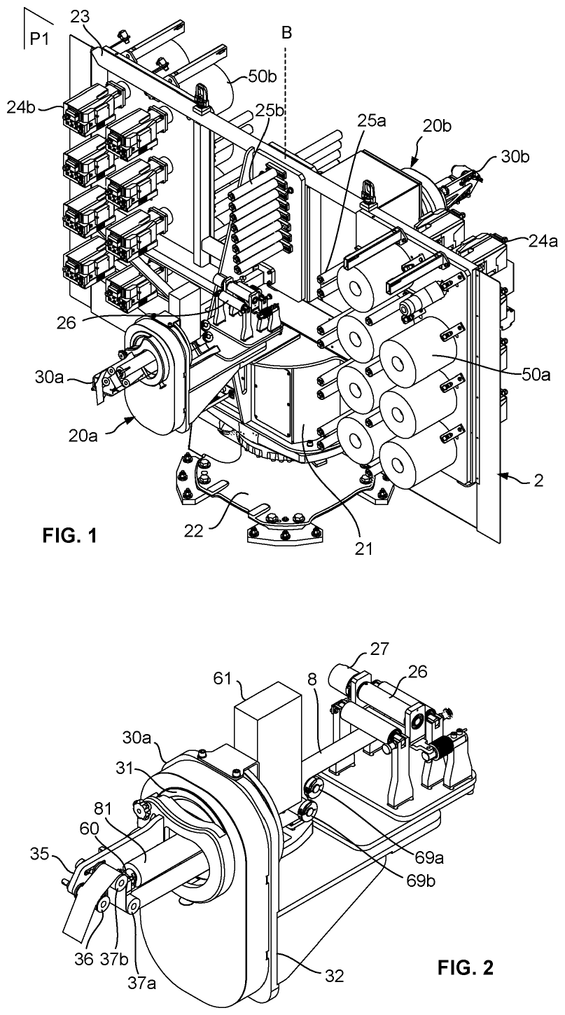

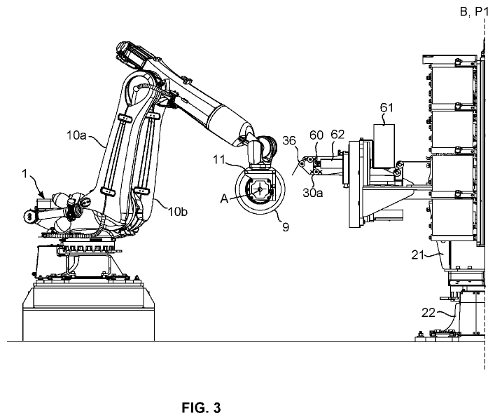

With reference to FIGS. 1 to 3, the filament winding machine according to the invention is used here for winding several fibers in the form of a fibrous web onto a body formed, for example, by a liner 9 for the production of tanks. The liner has a main longitudinal axis A and comprises a cylindrical central portion and two end domes fitted with mounting spindles. The winding machine comprises winding means 2, and a displacement system 1 carrying the liner 9. The winding means 2 comprise a first winding system 20a and a second winding system 20b mounted on a rotating support or carousel 21, as described in French patent applications nos. 2108411 and 2108412, filed on Aug. 2, 2021. The carousel 21 is mounted rotatably around a vertical rotation axis B on a frame 22 fixed to the floor, and can be driven in rotation by a motor controlled by a machine control unit. The two winding systems 30a, 30b are arranged on either side of a first vertical plane P1 passing through the axis B. A first winding system 20a, arranged on a first side of the plane P1 of the carousel, comprises a first winding head 30a associated with first fiber storage means 50a. The first storage means 50a comprise mandrels for receiving spools of continuous fibers. The machine is designed to enable the winding of a fibrous web formed of eight fibers, so the first storage means comprise eight mandrels. The mandrels are mounted on a support frame 23 fixed to the carousel, substantially along the plane P1. The first winding system comprises a tension regulation system 24a for regulating the tension of each fiber of the web, comprising first tension regulation motors associated with first mandrels, these first motors being positioned on the second side of the carousel. The first winding system further comprises first guide means 25a, 25b, 26, for guiding the fibers unwound from the bobbins towards the head in the form of a fibrous web 8 in which the fibers are substantially arranged edge-to-edge. In the embodiment illustrated, the fibers unwound from the spools pass over first return rollers 25a and then second return rollers 25b, to be gathered together at guide rollers 26 in the form of a fibrous web.

With reference to FIGS. 2, 4 and 5, the winding head 30a comprises a mobile ring 31 mounted rotatably around a horizontal axis C on a head support 32 which is fixedly mounted on the carousel. For this assembly, a fixed ring 33 is mounted on the head support, the mobile ring 31 being mounted on the fixed ring with the interposition of a bearing system 34. The mobile ring 31 is rotated by a motor 38 mounted on the head support 32, and a belt 39 meshing with a pinion 38a on the motor shaft and teeth 40 on the mobile ring, present on its outer surface. An arm 35 is mounted on the mobile ring and extends outwardly, on the downstream side of the mobile ring, substantially parallel to the axis C. A final guide member 36 and two intermediate guide members 37a, 37b are mounted on this arm. The fibrous web coming from the aforementioned guide rollers 26 passes through the mobile ring, over the intermediate guide members and then over the final guide member. The final guide member is formed here by a final roller 36 mounted in a cantilevered, fixed manner at the end of the arm, its longitudinal axis D1 is arranged perpendicular to the axis C, axis C passing substantially through longitudinal axis D1. The intermediate guide members are formed by a first intermediate roller 37a and a second intermediate roller 37b, cantilever-mounted on arm, between the final roller 36 and the mobile ring 31. Each intermediate roller is mounted fixedly or rotatably on the arm around its longitudinal axis D2, D3, preferably fixedly. Their longitudinal axes D2, D3 are arranged perpendicularly to the axis C and are arranged on either side of the latter, so that the fibrous web exiting from the mobile ring passes over the first intermediate roller 37a and then the second intermediate roller 37b, the strand 81 of the fibrous web between the first intermediate roller and the second intermediate roller being arranged substantially perpendicularly to the axis C.

The second winding system 20b is identical to the first winding system 20a, and comprises a second winding head 30b mounted pivotably around a horizontal axis C on a head support arranged on the second side of the plane P1 of the carousel, second fiber storage means 50b comprising mandrels associated with second tension regulating motors 24b, and second guide means for guiding the fibers in the form of a fibrous web towards the winding head. The second mandrels are mounted on the same support frame 23, the second tension regulating motors 24b being positioned on the first side of the carousel.

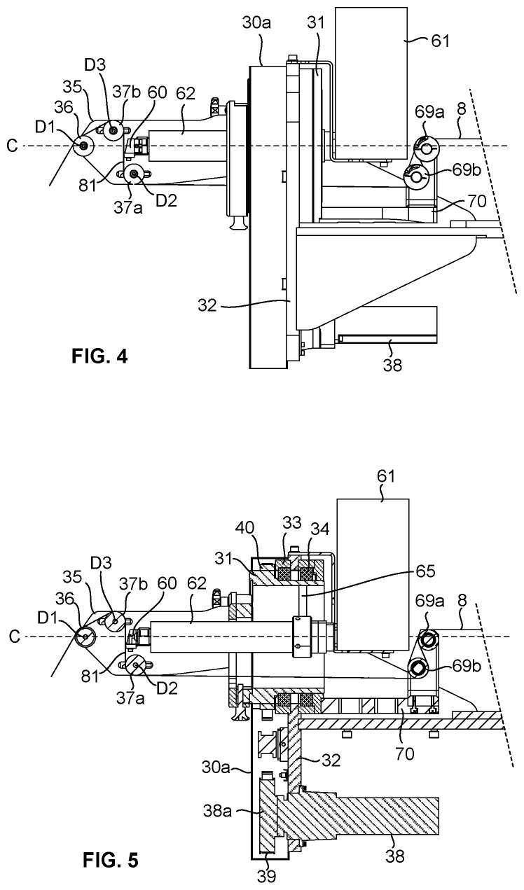

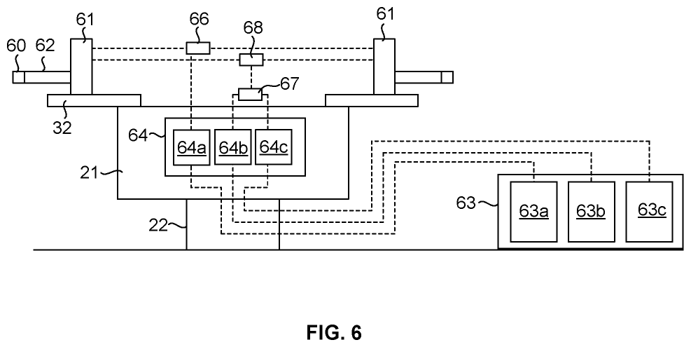

The machine is used with dry fiber spools, the machine being according to the embodiments of the invention equipped with a resin application system for applying in-line a resin composition to the fibrous web during the winding operation. With reference to FIGS. 4 to 6, the resin application system comprises application means formed by a slit nozzle 60 mounted on each winding head, distribution means 61, 62 for feeding the resin composition to the slit nozzle, also mounted on each winding head, resin storage means 63, and dosing means 64. The dispensing means comprise a valve system 61 and a static mixer 62 to which the nozzle is directly connected. The valve system 61 here comprises two inlets connected to the dosing means to be fed with at least two constituent components of the resin composition, and an outlet to which the static mixer 62 is connected, the static mixer ensuring mixing of the two components. The valve system is fixedly mounted on the head support 32 and is arranged upstream of the mobile ring 31 with respect to the running direction of the fibrous web. The static mixer is rotatably mounted at the outlet of the valve system, is arranged along the C axis and extends through the mobile ring. The static mixer is mechanically connected by at least one connecting bar 65 to the mobile ring, so as to be rotationally fixed to the mobile ring. The slot nozzle comprises, in a manner known per se, two plates or bars enclosing a foil provided with a slot. One of the two bars is provided with a feed channel, opening onto the slot and connected at the inlet to the discharge orifice of the static mixer. The slot nozzle enables the resin composition delivered by the static mixer to be spread over the fibrous web in the form of a layer or film. The width of the layer is defined by the width of the slot in the foil. The slot nozzle is arranged on the head so as to come into contact with the fibrous web, or to be flush with the fibrous web, in order to apply the resin composition to one main face of the fibrous web over substantially its entire width, at the strand 81 arranged between the first intermediate roller 37a and the second intermediate roller 37b. To ensure correct positioning of the slit nozzle relative to the strand, the two intermediate rollers are mounted adjustably on the arm in the direction parallel to the axis C. To displace the fibrous web from the axis C, and thus free up space for the static mixer, the fibrous web coming from the rollers 26 passes over two return rollers 69a, 69b, arranged upstream of the mobile ring, and mounted on an arm 70 extending from the mobile ring and fixed in rotation to the latter. The axis of the return rollers 69a, 69b are arranged parallel to the axis D1 of the final roller 36, the second return roller 69b is arranged so that the strand extending from this second return roller and the first intermediate roller 37a is substantially parallel to the axis C. The resin storage means 63 will be adapted to the different packaging and volumes of the components of the resin composition used. The storage means comprise, for example, a tank of the melter type, drum vacuum type or pressurized pot type for each component. The dosing means 64 comprise one dosing pump per component, each pump's input being connected to a tank, and its output being connected to the two valve systems 61.

In the present illustrated embodiment, the resin supply system is provided for the hot application of an epoxy-type resin composition. The resin composition applied is formed from a resin component, a hardener component and a catalyst component, the latter two components being mixed upstream of the valve systems 61 to form a reactive component. The storage means 63 comprise three tanks 63a, 63b, 63c for the resin component, the hardener component and the catalyst component respectively, connected individually by flexible hoses to three dosing pumps 64a, 64b, 64c. The output of the dosing pump 64a of the resin component is connected to the input of a first 1-in/2-out valve, referenced 66, each output of which is connected to a first input of a valve system 61 via flexible hoses. The other two dosing pumps 63b, 63c are connected at their output to the two inputs of a manifold block 67 for mixing the hardener component and the catalyst component, the output of the manifold block being connected to the input of a second 1-in/2-out valve, referenced 68, each output of which is connected to a second input of a valve system 61. The storage means 63 are located on the ground, at a distance from the carousel 21, while the dosing means 64 are mounted on the carousel. The flexible hoses connecting the storage means to the dosing means pass, for example, through the center of the frame and have an extra length allowing the carousel to rotate relative to the frame by at least +180° and −180° around the axis B. The flexible hoses used for the resin component between the resin tank, the resin dosing pump and the valve systems 61 are heated hoses. Similarly, the static mixer of each distribution means is fitted with a heated sleeve. Preferably, each nozzle and each valve system are also equipped with heating means. The resin composition can thus be hot applied and at the desired viscosity to the fibrous web. By way of example, the application system is used to hot apply, at a temperature of about 50° C., a resin composition comprising an epoxy resin component, resin composition having a viscosity at 50° C. of 100 to 200 Pa·s. In the present embodiment, the mixing of the resin component and the reactive component is carried out at the head as close as possible to the nozzle which is connected directly to the static mixer. Advantageously, the static mixer is of the disposable type and is replaced regularly.

The displacement system 1 comprises, for example, as described in the aforementioned patent applications, two polyarticulated arms or robots 10a, 10b for carrying the liner, the polyarticulated robots being equipped at the end with a mounting device 11 for mounting the liner by its end spindles to the two polyarticulated robots, and for driving the liner in rotation around its axis A. Each poly-articulated robot is of the six-axis robot type, known per se, mounted fixed to the floor, a mounting device 11 being assembled to the end wrist of each poly-articulated robot. At least one of the two mounting devices is equipped with a motor for driving the liner in rotation. Alternatively, the displacement system comprises a single poly-articulated robot for carrying the liner 9, the wrist of the poly-articulated robot being equipped at the end with a gripping device for carrying the liner by its end spindles.

The carousel can be moved between two positions by a rotation of +180° or −180° around its axis B. In a first position of the carousel, the first winding system 20a is in an active position, its head 30a can be used for filament winding operations on a liner carried and rotated by the displacement system. The second winding system 20b is in an inactive position corresponding to a maintenance position. The winding operation is carried out by the machine control unit, which controls the two poly-articulated robots along programmed paths to move the liner relative to the winding head 30a, as well as the drive motor(s) for rotating the liner around its axis A, and the motor 38 for rotating the winding head around its rotation axis C. The control unit controls the first and second valves 66, 68 to supply the valve system 61 associated with the head 30a in the active position with reactive component and resin component. The dosing pumps 63a, 63b and 63c are controlled by the control unit to deliver the desired quantity of each component depending on the speed of the fibrous web. One of the guide rollers 26, for example, is fitted with an encoder 27 which communicates the speed of the fibrous web to the control unit. During winding operations with the first winding system, an operator can carry out maintenance operations in complete safety on the second winding system 20b in the maintenance position. In particular, the operator can replace the spools of the second winding system, and pass the fibers of the new spools through the guide means to the guide member. The operator can also carry out cleaning and/or replacement operations on the final roller 36 and/or the intermediate rollers 37a, 37b of the second head and/or the guide means 25a, 25b, 26, and/or maintenance operations on the nozzle, the valve system and/or the static mixer. When it is necessary to change the spools of the first winding system, the carousel is moved to its second position by rotating it by 180° around its axis C. In this second position, the second winding system is in the active position to enable winding operations to be carried out via its winding head, while the first winding system is in the maintenance position for the aforementioned maintenance operations.

Advantageously, the first winding system and the second winding system each comprise an automatic attachment device, enabling the fibrous web to be attached automatically, without manual intervention, to the body at the start of filament winding, and an automatic cutting device, enabling the fibrous web to be cut automatically at the end of winding.

According to another embodiment, the winding means comprise three winding systems mounted on a rotating support or carousel, with three winding heads arranged at 120° to each other, each equipped with a valve system and a slot nozzle, as described above. The resin application system then comprises, instead of the aforementioned two 1-in/2-out valves, two 1-in/3-out valves, for selectively feeding one of the three valve systems associated with the three winding heads.

Although the invention has been described in relation to a particular embodiment, it is quite clear that it is by no means limited thereto and that it includes all the technical equivalents of the means described as well as their combinations if these fall within the scope of the invention.

1. A Filament winding machine for winding a fibrous web comprising at least one continuous fiber, onto a body the machine comprising
winding means comprising at least one winding head associated with fiber storage means and comprising a final guide member
a displacement system able to drive the body in rotation and to effect a relative displacement of the body with respect to the winding means for winding the fibrous web onto the body, and
a resin application system able to apply a resin composition to the fibrous web,
wherein the resin application system comprises application means comprising at least one nozzle able to coat one of the main faces of the fibrous web with a resin composition, at the winding head, upstream of the final guide member and a feed device able to feed the resin composition to the said nozzle at a rate which is regulated depending on the speed of the fibrous web.

2. Machine according to claim 1, wherein the winding head comprises a final guide member against which the fibrous web comes into contact by a first main face, the said nozzle being able to apply a resin composition to the second main face of the fibrous web.

3. Machine according to claim 1, wherein the nozzle is a slot nozzle equipped with a foil defining a distribution slot.

4. Machine according to one of claim 1, wherein the final guide member is formed by a final roller mounted non rotatably around its longitudinal axis (D1).

5. Machine according to one of claim 1, wherein the winding head comprises, upstream of the final guide member, one intermediate guide member or two intermediate guide members, the said-nozzle being able to apply the resin composition to the fibrous web as it passes over an intermediate guide member, or to the strand of fibrous web arranged between two intermediate members or arranged between an intermediate guide member and the final guide member.

6. Machine according to claim 1, wherein the final guide member is mounted pivotably on a head support around a rotation axis (C), the said-winding head comprising a motor able to pivot the said final guide member around the said rotation axis, the nozzle being mounted pivotably with the final guide member on the head support.

7. Machine according to claim 6, wherein the winding head comprises a mobile ring mounted rotatably around its main axis (C) on a fixed ring which is assembled in a fixed manner on the head support, the mobile ring being provided with at least one arm extending substantially parallel to the main axis, carrying at the end the final guide member, said the nozzle being fixed in rotation to the mobile ring.

8. Machine according to one of claim 1, wherein the feed device comprises resin storage means, dosing means and distribution means, the distribution means including a valve system comprising at least two inlets connected to the dosing means to be fed with at least two constituent components of the resin composition, and an outlet connected to a static mixer, said nozzle being connected to the outlet of said static mixer.

9. Machine according to claim 7, wherein the valve system is mounted on the head support, the static mixer is mounted rotatably at the outlet of the valve system and extends through the mobile ring, substantially along the main axis (C) of the mobile ring, the static mixer being fixed in rotation to the mobile ring, the nozzle is connected directly to the outlet of the static mixer.

10. Machine according to claim 8, wherein the winding means comprise at least two winding systems, each winding system comprising a winding head associated with fiber storage means, and equipped with a nozzle fed with resin composition by the static mixer which is connected to a valve system, the valve systems of the two winding systems being fed with components of the resin composition by common dosing means.

11. Machine according to claim 10, wherein the winding means comprise a rotating support, mounted rotatably around a rotation axis (B), on which at least two winding systems are mounted so that, by rotation of the rotating support around its rotation axis (B), each winding system can be moved into an active position, for the winding of a fibrous web by its winding head, and an inactive position, the feed device comprising common dosing means, mounted on the rotating support, able to selectively feed the valve system associated with the winding head of the winding system which is in the active position, and resin storage means disposed in the vicinity of the rotating support feeding the dosing means.

12. Method for manufacturing a fiber-reinforced part comprising the filament winding of a fibrous web onto a body, wherein the filament winding is carried out by means of a filament winding machine according to claim 1, with in-line application, by coating, of a resin composition onto a first main face of the fibrous web.

13. Method according to claim 12, wherein it comprises in-line coating by means of a nozzle of a resin composition having a viscosity at 50° C. of at least 20 Pa·s, preferably of at least 100 Pa·s, more preferably of between 100 and 200 Pa·s.

14. Method according to claim 12, wherein the winding of the fibrous web is performed so that the main face coated with resin composition is oriented towards the body, the method comprising a first step of heating the wound body in order to reduce the viscosity of the resin composition and promote impregnation, then a second step of heating the wound body in order to polymerize the resin composition.

15. Method according to claim 12, for producing a fiber-reinforced part such as a high-pressure vessel, wherein the body constitutes a liner, the fiber-reinforced part being formed from the liner and the winding of fibrous web.
